(19) United States
(12) Patent Application Publication
(10) Pub. No.: US 2004/0196553 A1
(43) Pub. Date: Oct. 7, 2004

(54) Observation apparatus and observation system

(75) Inventors: Kazuo Banju, Hachioji-shi (JP); Masahiro Kudo, Hino-shi (JP); Shingo Nogami, Machida-shi (JP); Takahiro Kogasaka, Hachioji-shi (JP); Kazuo Morita, Hachioji-shi (JP); Masayuki Irie, Hachioji-shi (JP)

Correspondence Address: OSTROLENK FABER GERB & SOFFEN, 1180 AVENUE OF THE AMERICAS, NEW YORK, NY, 100368403

(73) Assignee: Olympus Corporation

(21) Appl. No.: 10/818,824

(22) Filed: Apr. 5, 2004

(30) Foreign Application Priority Data
Apr. 4, 2003 (JP) 2003-101646

(51) Int. Cl. G02B 21/22

(52) U.S. Cl. 359/466; 359/462

(57) ABSTRACT

An observation apparatus includes a housing, a pair of display devices capable of correspondingly displaying a pair of different images for stereoscopic observation obtained from a stereoscopic observation mechanism, an eyepiece portion having a pair of observation windows, a window portion formed having an opening through which an external area around the housing can be observed by means of the eyepiece portion, and a shutter which opens and closes the window portion. The display devices is located in the housing so as to be connected to the stereoscopic observation mechanism, through which an observation target region can be observed stereoscopically. The pair of observation windows of the eyepiece portion is attached to the housing, and images displayed individually on the display devices can be observed by left and right eyes through the observation windows, individually. The window portion and the shutter are attached to the housing.

### CROSS-REFERENCE TO RELATED APPLICATIONS

This application is based upon and claims the benefit of priority from prior Japanese Patent Application No. 2003-101646, filed Apr. 4, 2003, the entire contents of which are incorporated herein by reference.

### BACKGROUND OF THE INVENTION

1. Field of the Invention

The present invention relates to an observation apparatus and an observation system, located across the field of operation and capable of observing the field.

2. Description of the Related Art

As is described in Jpn. Pat. Appln. KOKAI Publication No. 9-98985, for example, face- or head-worn image display devices are known devices that have a miniature monitor therein. These display devices can be conveniently used in a manner such that they are worn by an operator. Thus, these devices are used to display images that are obtained by picking up a region of a patient's body to be operated or treated, by means of an image pickup unit, at the site of medical practice, such as in a surgical operation.

### BRIEF SUMMARY OF THE INVENTION

According to an aspect of the present invention, an observation apparatus includes: a housing; a pair of display devices which is located in the housing so as to be connected to a stereoscopic observation mechanism, through which an observation target region is observed stereoscopically, and correspondingly displays a pair of different images for stereoscopic observation obtained from the stereoscopic observation mechanism; an eyepiece portion attached to the housing and having a pair of observation windows through which images displayed individually on the display devices is observed by left and right eyes, individually; a window portion attached to the housing and formed having an opening through which an external area around the housing is observed by means of the eyepiece portion; and a shutter which is attached to the housing and opens and closes the window portion.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing the way a surgical operation is performed with use of an observation system according to a first embodiment;

FIG. 2 is a schematic view showing the internal configuration of a stereoendoscope according to the first embodiment;

FIG. 3 is a schematic perspective view of a stereoscopic observation apparatus according to the first embodiment;

FIG. 4A is a plan view of the internal structure of the stereoscopic observation apparatus according to the first embodiment taken from above the housing;

FIG. 4B is a side view of the internal structure of the stereoscopic observation apparatus taken along line 4B-4B of FIG. 4A;

FIG. 5A is a plan view of an open window portion of the stereoscopic observation apparatus according to the first embodiment;

FIG. 5B is a sectional view of the open window portion taken along line 5B-5B of FIG. 5B;

FIG. 6A is a block diagram schematically showing connections between the stereoendoscope and the stereoscopic observation apparatus of the observation system according to the first embodiment;

FIG. 6B is a block diagram showing connections of a device for operating a shutter;

FIG. 7A is a plan view of the internal structure of a stereoscopic observation apparatus according to a second embodiment taken from above the housing;

FIG. 7B is a side view of the internal structure of the stereoscopic observation apparatus taken along line 7B-7B of FIG. 7A;

FIG. 8A is a plan view of an open window portion of the stereoscopic observation apparatus according to the second embodiment;

FIG. 8B is a sectional view of the open window portion taken along line 8B-8B of FIG. 8A;

FIG. 9A is a block diagram schematically showing connections between a stereoendoscope and a stereoscopic observation apparatus of an observation system according to the second embodiment;

FIG. 9B is a block diagram showing connections of a device for operating a shutter;

FIG. 10A is a plan view of the internal structure of a stereoscopic observation apparatus according to a third embodiment taken from above the housing;

FIG. 10B is a side view of the internal structure of the stereoscopic observation apparatus taken along line 10B-10B of FIG. 10A;

FIG. 11A is a plan view of an open window portion of the stereoscopic observation apparatus according to the third embodiment;

FIG. 11B is a sectional view of the open window portion taken along line 11B-11B of FIG. 11A; and

FIG. 12 is a block diagram schematically showing connections between a stereoendoscope and a stereoscopic observation apparatus of an observation system according to the third embodiment.

### DETAILED DESCRIPTION OF THE INVENTION

Embodiments of an observation system according to the present invention will now be described with reference to the accompanying drawings.

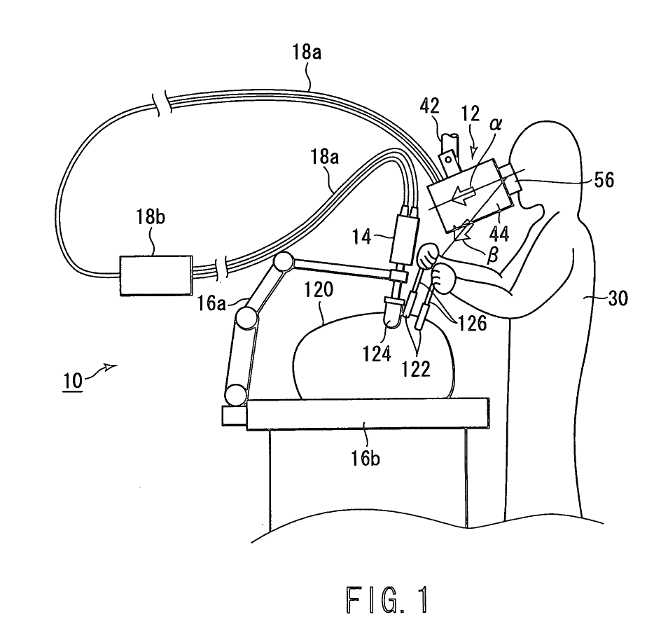

A first embodiment will be described with reference to FIGS. 1 to 6.

As shown in FIG. 1, an observation system 10 includes a stereoscopic observation apparatus 12 and a stereoendoscope (image pickup mechanism for stereoscopic observation) 14. The stereoendoscope 14 is held on a scope holder 16a that is mounted on a bed 16b. The respective one ends of cables 18a are connected to the stereoscopic observation apparatus 12 and the stereoendoscope 14, individually. A common controller 18b is connected to the respective other ends of the cables 18a.

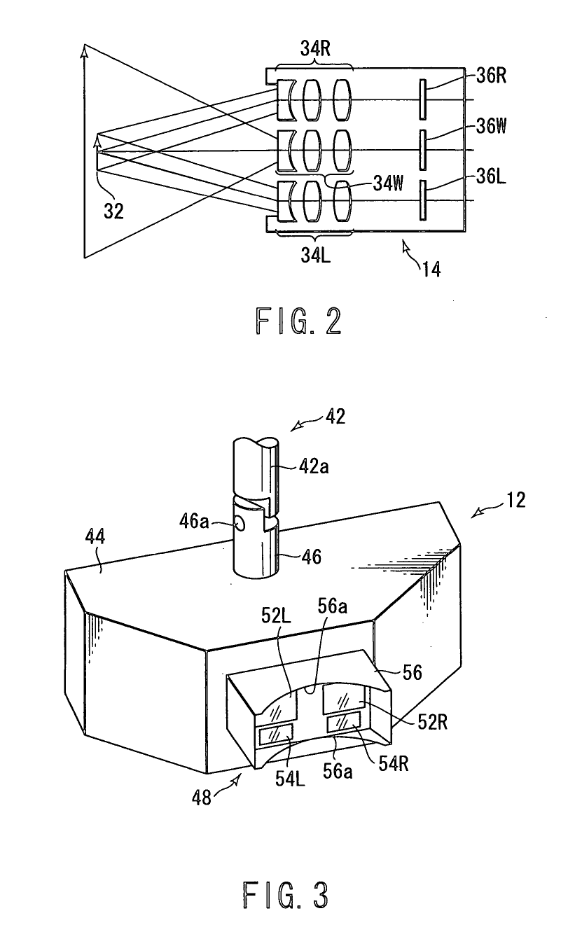

As shown in FIG. 2, the stereoendoscope 14 has, in its casing, a pair of optical systems 34L and 34R, left and right, and left- and right-hand image pickup elements 36L and 36R for picking images that are obtained from the optical systems 34L and 34R, respectively. The optical systems 34L and 34R have a parallax such that an observation target region 32 in a patient's body cavity can be observed stereoscopically. Thus, the paired image pickup elements 36L and 36R can pickup images of the target region 32.

The stereoendoscope 14 further has, in its casing, another optical system 34W, besides the left- and right-hand optical systems 34L and 34R, and an image pickup element 36W for picking up an image from the optical system 34W. The optical system 34W is located between the optical systems 34L and 34R. The image pickup element 36W is located between the left- and right-hand image pickup elements 36L and 36R. Accordingly, a wide area around the observation target region 32 in the patient's body cavity can be observed two-dimensionally by means of the optical system 34W. Thus, the casing of the stereoendoscope 14 contains three observation optical systems in total.

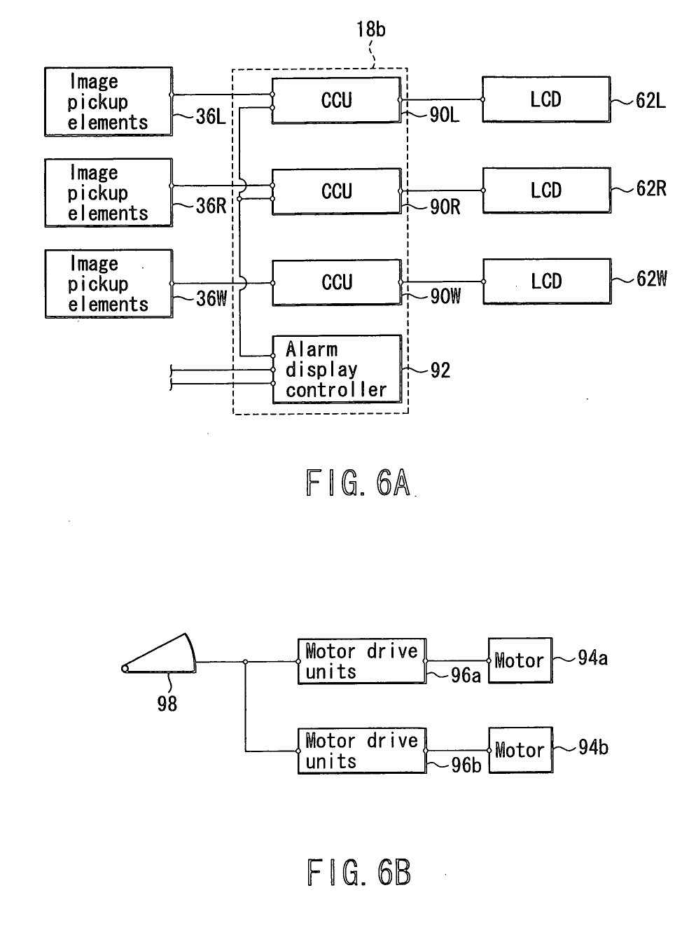

Signals from these three image pickup elements 36L, 36R and 36W are transmitted to three camera control units (hereinafter referred to as CCUs and mentioned later) 90L, 90R and 90W (see FIG. 6B), all of which are attached to the controller 18b shown in FIG. 1, by means of the cables 18a. The CCUs 90L, 90R and 90W convert the signals from the image pickup elements 36L, 36R and 36W into video signals, individually.

As shown in FIGS. 1 and 3, the stereoscopic observation apparatus 12 is connected to a support arm (supporting means) 42 that is suspended from a ceiling, for example. The dead weight of the observation apparatus 12 is entirely canceled by the weight of a counterbalance (not shown) that is attached to the support arm 42. If the observation apparatus 12 is placed in any desired position, therefore, it is held on the support arm 42 as if it were suspended in the air in that position.

As shown in FIG. 3, the stereoscopic observation apparatus 12 includes a housing (casing) 44, a post 46, and an observation window unit 48. The post 46 is mounted on the upper surface of the housing 44. The post 46 is coupled to a distal arm portion 42a of the support arm 42 for derricking motion by means of a derricking shaft 46a. Interposed between the post 46 and the distal arm portion 42a is a friction generating mechanism (not shown), such as a disc spring, whereby the two members are subjected to a moderate force of sliding friction. Therefore, the stereoscopic observation apparatus 12 can be tilted with respect to the support arm 42 around the shaft 46a. If the observation apparatus 12 is released from a hand's hold in any desired position, its postural position can be kept as it is. When the observation apparatus 12 is worked, the housing 44 is normally located diagonally above the field of operation. Thus, the observation apparatus 12 is located in a position such that it shields the field of operation to be observed by an operator 30 (see FIG. 1).

The observation window unit (eyepiece unit) 48 for the operator's stereoscopic observation is attached to the wall surface portion of the housing 44 of the stereoscopic observation apparatus 12 on the operator's side. The window unit 48 is provided with a first left-eye observation window 52L and a first right-eye observation window 52R, which are located on the upper side for stereoscopic observation. Further, the window unit 48 is provided with a second left-eye observation window 54L and a second right-eye observation window 54R, which are located on the lower side for any other observation than stereoscopic observation. In other words, the window unit 48 is provided with the first and second left-eye observation windows 52L and 54L and the first and second right-eye observation windows 52R and 54R.

The distance between the respective centers of the first left-eye observation window 52L and the first right-eye observation window 52R on the upper side is adjusted to the distance between the respective pupils of the operator's or observer's left and right eyes. Likewise, the distance between the respective centers of the second left-eye observation window 54L and the second right-eye observation window 54R on the lower side is adjusted to the distance between the respective pupils of the observer's left and right eyes.

The observation window unit 48, having these observation windows 52R, 52L, 54L and 54R, are surrounded by an eyeshade 56 on the housing 44. The eyeshade 56 serves as an observation eyepiece unit the observer (operator) 30 uses for observation. In observing the observation target region 32, as shown in FIG. 1, an edge portion 56a of the eyeshade 56 is applied to the face of the operator 30, and the stereoscopic observation apparatus 12 is positioned with respect to the operator 30.

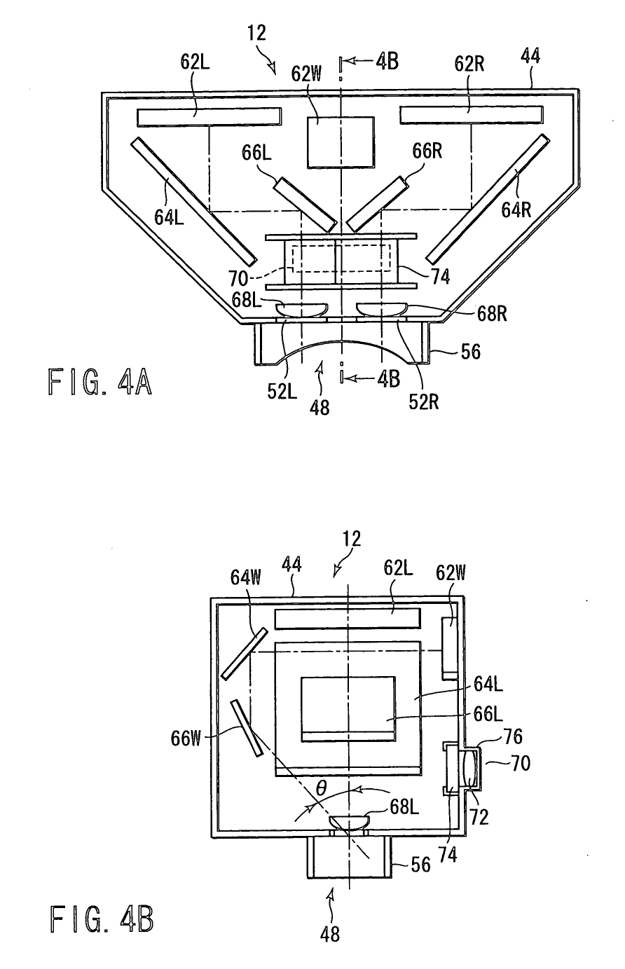

In an observation position such that the stereoscopic observation apparatus 12 is positioned in this manner, the first observation windows 52L and 52R for stereoscopic observation are arranged on a visual line indicated by arrow α, which is directly opposite to the eyes of the operator 30. The second observation windows 54L and 54R (see FIG. 3) for any other observation than stereoscopic observation through an open window portion 70 (see FIG. 4A), which will be mentioned later, are arranged on a visual line indicated by arrow β, which is directed diagonally downward.

FIGS. 4A and 4B show the internal structure of the stereoscopic observation apparatus 12. FIG. 4A is a plan view of the internal structure, and FIG. 4B is a side view of the internal structure.

As shown in FIGS. 4A and 4B, a pair of liquid crystal monitors (hereinafter referred to as LCDs) 62L and 62R, for use as left- and right-hand display devices, are arranged in the housing 44 of the stereoscopic observation apparatus 12. These LCDs 62L and 62R are juxtaposed and opposed parallel to the first observation windows 52L and 52R, respectively. Left- and right-hand images that are picked up by the image pickup elements 36L and 36R of the stereoendoscope 14 are transmitted through the cables 18a and the controller 18b and displayed on the LCDs 62L and 62R, respectively, in a separate manner.

A pair of first mirrors 64L and 64R, left and right, are arranged on the respective optical axes of the images displayed on the LCDs 62L and 62R, respectively. These first mirrors 64L and 64R reflect the images on their corresponding LCDs 62L and 62R squarely, for example.

A pair of second mirrors 66L and 66R, left and right, are arranged on the respective optical axes of the images reflected by the first mirrors 64L and 64R, respectively. These second mirrors 66L and 66R further reflect the images from the first mirrors 64L and 64R squarely, for example. Thus, the images displayed on the LCDs 62L and 62R are reflected by the first mirrors 64L and 64R and the second mirrors 66L and 66R. The respective optical axes of the images displayed on the LCDs 62L and 62R extend parallel to the respective optical axes of the images reflected by the second mirrors 66L and 66R.

Eyepiece lenses 68L and 68R are arranged on the respective optical axes of the images reflected by the second mirrors 66L and 66R, respectively. Thus, the images displayed on the LCDs 62L and 62R are enlarged into a predetermined picture size by the eyepiece lenses 68L and 68R.

The first observation windows 52L and 52R for stereoscopic observation are arranged on the respective optical axes of the eyepiece lenses 68L and 68R, respectively. Thus, the enlarged images on the LCDs 62L and 62R are observed stereoscopically through the first left-eye observation window 52L and the first right-eye observation window 52R by the operator 30. The first observation windows 52L and 52R, left and right, may be provided with eyepiece optical systems (not shown) for enlarged observation of the images displayed on the respective display screens of the LCDs 62L and 62R.

A miniature liquid crystal monitor (hereinafter referred to as miniature LCD) 62W as another display device is located in the housing 44 of the stereoscopic observation apparatus 12. The miniature LCD 62W is attached to the bottom of the housing 44, for example. The image picked up by the image pickup element 36W of the stereoendoscope 14 is transmitted through the cables 18a and the controller 18b and displayed on the miniature LCD 62W so that a wide range of the interior of the patient's body cavity can be observed two-dimensionally.

A first reflecting mirror 64W is located on the optical axis of the image displayed on the miniature LCD 62W, that is, near the upper surface of the housing 44. The first reflecting mirror 64W reflects the image on the LCD 62W squarely, for example. A second reflecting mirror 66W is located on the optical axis of the image reflected by the first reflecting mirror 64W. The second reflecting mirror 66W further reflects the image from the first reflecting mirror 64W in a given direction. The eyepiece lenses 68L and 68R are arranged on the optical axis of the image reflected by the second reflecting mirror 66W. The image displayed on the LCD 62W is enlarged into a predetermined picture size by the eyepiece lenses 68L and 68R. The enlarged image on the LCD 62W is observed stereoscopically through the first left-eye observation window 52L, for example, by the operator 30. Thus, the optical axis for the observation of the miniature LCD 62W is located diagonally above the visual line (indicated by arrow α, see FIG. 1) for the observation of the LCDs 62L and 62R through the first left-eye observation window 52L. Thus, the visual line is moved to the space above the housing 44 in two-dimensionally observing the area around the observation target region 32 that is displayed on the LCD 62W.

As this is done, an angle θ is formed between the optical axis of the image that is reflected by the second reflecting mirror 66W and the optical axis of each of the images that are reflected by the second mirrors 66L and 66R, as shown in FIG. 4B. The angle θ has a value such that an ordinary observer cannot easily visually recognize the observation image in its corresponding direction unless he/she moves his/her eyes (visual line).

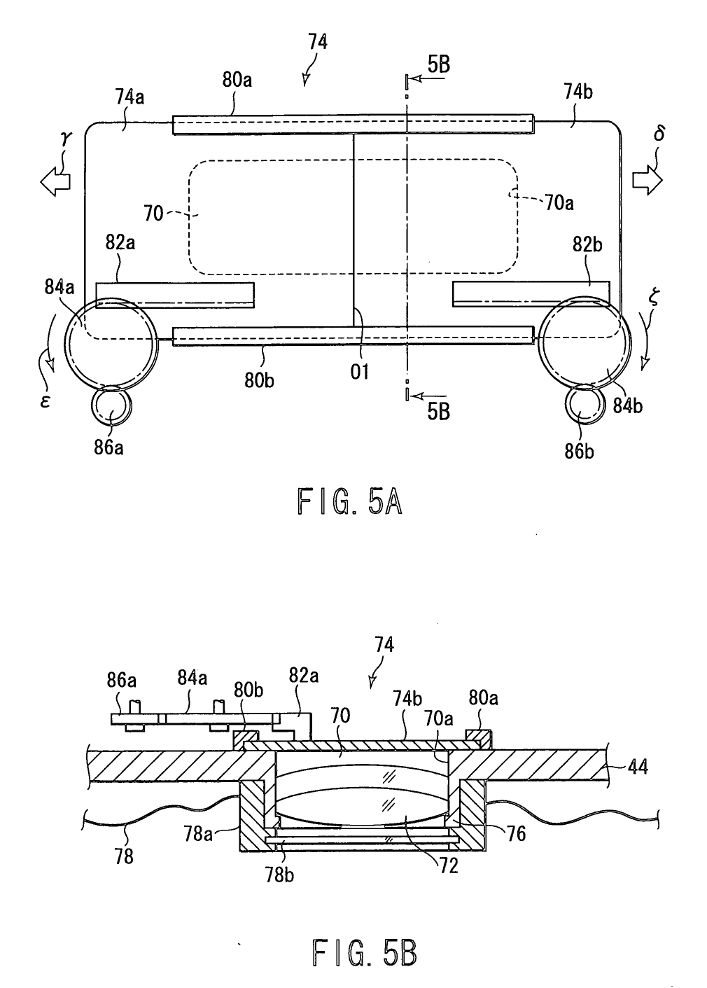

As shown in FIGS. 4A and 4B, the open window portion 70 is provided in the bottom of the housing 44 of the stereoscopic observation apparatus 12. As shown in FIG. 5B, the window portion 70 is provided with an opening frame portion 76 that defines an opening in the bottom of the housing 44. The frame portion 76 is formed having a square hole (opening) 70a inside. The square hole 70a is defined by a projection that protrudes from the lower surface of the housing 44 and doubles as a body tube. A magnifier 72 having a square external shape is fixedly attached to the interior of the square hole 70a with use of an adhesive agent (not shown).

A shutter 74 for switching the magnifier 72 is further located in the opening frame portion 76. Thus, the magnifier 72 has optical specifications such that the operator 30 can observe the field of operation outside the housing 44, e.g., an area around trocars 122 and 124 (mentioned later), in an enlarged form when his/her visual line is downward as indicated by arrow β in FIG. 1.

When the stereoscopic observation apparatus 12 is worked, as shown in FIG. 5B, a removable drape cap 78a, molded from urethane resin, for example, is fitted on the outer periphery of the projection of the opening frame portion 76. The drape cap 78a is provided with a transparent glass drape cover 78b, which conceals the surface of the magnifier 72 from the space outside the housing 44. The drape cap 78a is attached to a sterilized drape 78 that covers the housing 44 of the observation apparatus 12. The sterilized drape 78 entirely can cover the observation apparatus 12 including the support arm 42, thereby keeping clean the space near the working area for surgical operation.

As shown in FIGS. 4A and 4B, the square hole 70a is opened and closed by means of the shutter 74. The shutter 74 is provided with a pair of shielding plates 74a and 74b that can open and close the opening inside the square hole 70a. These shielding plates 74a and 74b have the same shape.

As shown in FIG. 5A, the shielding plates 74a and 74b are guided by rails 80a and 80b, respectively, for straight sliding motion in the same direction. The rails 80a and 80b, which are located individually on the opposite sides of their corresponding plates 74a and 74b, extend parallel to each other.

As shown in FIGS. 5A and 5B, racks 82a and 82b are fixedly attached to the inner surface portions of the shielding plates 74a and 74b, respectively, so as to extend parallel to the rails 80a and 80b. Thus, the racks 82a and 82b are arranged on the same axis.

Spur gears (pinions) 84a and 84b of the same size are in mesh with the racks 82a and 82b, respectively. Driving gears 86a and 86b are in mesh with the spur gears 84a and 84b, respectively. The driving gears 86a and 86b, which have the same size, are fixed to the drive shafts of motors 94a and 94b (see FIG. 6B), respectively, which will be mentioned later.

The racks 82a and 82b, spur gears 84a and 84b, and driving gears 86a and 86b are located bisymmetrically with respect to a center line O1 of the square hole 70a that extends in the vertical direction of the drawing plane of FIG. 5A. Thus, all the component members of the shutter 74 except the rails 80a and 80b are paired left and right, as shown in FIG. 5A.

FIG. 5A shows a closed state in which the respective end faces of the two shielding plates 74a and 74b are butted each other in the center of the square hole 70a. In opening the left- and right-hand shielding plates 74a and 74b or moving them in the directions of arrows γ and δ, respectively, the gear 86a is rotated in a direction such that the spur gear 84a that is located on the left-hand side of FIG. 5A rotates in the direction indicated by arrow ε. The gear 86b is rotated in a direction such that the spur gear 84b that is located on the right-hand side rotates in the direction indicated by arrow ξ. The motors 94a and 94b are driven in this manner. In closing the shielding plates 74a and 74b, the motors 94a and 94b are rotated in opposite directions.

FIGS. 6A and 6B are block diagrams showing connections between the apparatus elements according to the present embodiment.

As shown in FIG. 6A, the LCDs 62L and 62R and the miniature LCD 62W are connected to the three CCUs 90L, 90R and 90W, respectively, in the controller 18b. The CCUs 90L, 90R and 90W are connected with the image pickup elements 36L, 36R and 36W, respectively, which are arranged in the stereoendoscope 14 and transmit image signals to the CCUs 90L, 90R and 90W, respectively.

The controller 18b incorporates an alarm display controller 92 having a display mechanism, which is connected to the three CCUs 90L, 90R and 90W and makes the LCDs 62L and 62R and the miniature LCD 62W display alarms. The alarm display controller 92 is connected to an apparatus that measures the patient's vital sign, such as an electrocardiograph or sphygmomanometer, to receive information from it. Thus, the controller 92 constitutes a signal output device that outputs signals for any other information than the observation image obtained through the stereoendoscope 14. If a signal from the electrocardiograph, sphygmomanometer, or any other similar apparatus deviates from a predetermined range, a sign indicative of an alarm and an output signal for displaying the content of the alarm are delivered to the LCDs 62L and 62R and the miniature LCD 62W.

As shown in FIG. 6B, the motors 94a and 94b that drive the driving gears 86a and 86b of the shutter 74 are connected with motor drive units 96a and 96b, which drivingly control the motors 94a and 94b, respectively. A common footswitch 98 is connected to these two motor drive units 96a and 96b. If the footswitch 98 is stepped on, the motors 94a and 94b are actuated by the motor drive units 96a and 96b.

The following is a description of the way a surgical operation is performed by using the observation system 10 constructed in this manner.

As shown in FIG. 1, the abdominal wall or the like of a patient 120 is punctured with the trocars 122 for operative instruments and the trocar 124 for endoscope, which are each formed of a tube that leads to the body cavity. Operative instruments 126 are inserted into the patient's body cavity through the trocars 122 for operative instruments. In order to treat the interior of the body cavity of the patient 120, the operator (observer) 30 who looks into the stereoscopic observation apparatus 12 manipulates the instruments 126. The stereoendoscope 14 held on the scope holder 16a is inserted into the body cavity of the patient 120 through the trocar 124 for endoscope. The scope holder 16a is fixed in a suitable state.

In performing the surgical operation while observing the observation image from the stereoendoscope 14 by means of the stereoscopic observation apparatus 12, the operator 30 can turn his/her eyes substantially upon the region to be operated in a proper posture without regard to the presence of the observation apparatus 12. In order to start the operation in the proper posture, as shown in FIG. 1, the operator 30 suitably derricks the observation apparatus 12.

The signals for the observation images that are picked up by the image pickup elements 36L and 36R through the optical systems 34L and 34R of the stereoendoscope 14 are transmitted to the controller 18b through the cables 18a that are connected to the stereoendoscope 14. The signals are converted into video signals by means of the CCUs 90L and 90R of the controller 18b. The converted signals are transmitted to and displayed on the LCDs 62L and 62R in the housing 44 of the stereoscopic observation apparatus 12.

These images displayed on the LCDs 62L and 62R are reflected by the first mirrors 64L and 64R. The images reflected by the first mirrors 64L and 64R are further reflected by the second mirrors 66L and 66R. The images reflected by the second mirrors 66L and 66R are enlarged by the eyepiece lenses 68L and 68R and landed on the first observation windows 52L and 52R. If the operator 30 looks in at the first observation windows 52L and 52R in the direction of the visual line indicated by arrow a, therefore, he/she can enjoy a stereoscopic image of the observation target region 32 that is observed through the stereoendoscope 14.

If a wide area around the observation target region 32 must be observed during the treatment, the operator 30 lifts his/her eyes on the first observation windows 52L and 52R for the angle θ. In this case, the signal for the observation image that is picked up by the image pickup element 36W through the optical system 34W of the stereoendoscope 14 is transmitted to the controller 18b through the cables 18a that are connected to the stereoendoscope 14. The signal is converted into a video signal by means of the CCU 90W of the controller 18b. The converted signal is transmitted to and displayed on the miniature LCD 62W in the housing 44 of the stereoscopic observation apparatus 12.

The image displayed on the miniature LCD 62W is reflected by the first reflecting mirror 64W. The image reflected by the first reflecting mirror 64W is further reflected by the second reflecting mirror 66W. The image reflected by the second reflecting mirror 66W is enlarged by the eyepiece lens 68L and landed on the first left-eye observation window 52L. If the operator 30 looks in at the first observation window 52L and lifts his/her eyes, therefore, he/she can enjoy a two-dimensional image of the area around the observation target region 32 that is observed through the stereoendoscope 14.

Thus, the operator 30 can observe a desired wide area around the observation target region 32 by only lifting his/her eyes for the angle θ, without being deceived by the stereoscopic observation images displayed on the LCDs 62L and 62R. For the same reason, the operator can perform stereoscopic observation without being deceived by the two-dimensional image that is displayed on the miniature LCD 62W.

In some cases, a field of operation outside the housing 44 of the stereoscopic observation apparatus 12 (including an operative region shielded by the housing 44 and regions for the operative instruments), not the observation image obtained by means of the stereoendoscope 14, may be expected to be observed directly during the surgical operation. In externally inserting suture needles that are held by means of the operative instruments 126 into the body cavity of the patient 120, for example, the instruments 126 are inserted again into the trocars 122 after they are drawn out of the body cavity and made to hold the needles. In carrying out this work, the operator 30 desires directly to observe the positions of inlets for the trocars 122 for instruments in the direction indicated by arrow β.

In this case, the operator 30 must open the shielding plates 74a and 74b of the shutter 74 of the stereoscopic observation apparatus 12 and look in at the second left-eye observation window 54L and the second right-eye observation window 54R. Apertures for the trocars 122 for operative instruments and working regions for the suture needles held by means of the operative instruments 126 are observed through the open window portion 70, magnifier 72, and glass drape cover 78b.

After the suture needles are inserted into the trocars 122 for operative instruments, the operator 30 looks in again at the first observation windows 52L and 52R in the direction of the visual line indicated by arrow a as he/she restarts treatment such as suturing under stereoscopic observation through the stereoendoscope 14. After the observation through the stereoendoscope 14 is restarted, the shielding plates 74a and 74b of the shutter 74 are closed. When the housing 44 is looked in at the first observation windows 52L and 52R, therefore, a phenomenon that hinders stereoscopic observation, such as incidence of light through the open window portion 70, can be prevented. Thus, the observation apparatus 12 can perform definite stereoscopic observation.

This work is carried out in the following manner.

The footswitch 98 is stepped on first. Thereupon, the motor drive units 96a and 96b are actuated to rotate the motors 94a and 94b in their respective given directions. When the driving gears 86a and 86b that are fixed to the respective drive shafts of the motors 94a and 94b are rotated, as shown in FIG. 5A, the spur gears 84a and 84b are rotated in opposite directions with respect to the driving gears 86a and 86b. In this case, the spur gears 84a and 84b are rotated in the directions indicated by arrows ε and ξ, respectively, in FIG. 5A. When the spur gears 84a and 84b are rotated, their mating racks 82a and 82b move.

As this is done, the shielding plates 74a and 74b move away from each other along the rails 80a and 80b, since the racks 82a and 82b are fixed to the shielding plates 74a and 74b, respectively. In this state, the operator 30 looks in at the second observation windows 54L and 54R in the direction of the visual line indicated by arrow β. The regions around the trocars 122 and 124, for example, are enlargedly observed from the second observation windows 54L and 54R through the magnifier 72 and the glass drape cover 78b as well as through the open window portion 70.

After the regions around the trocars 122 and 124 are enlargedly observed, for example, the footswitch 98 is stepped on again. The motor drive units 96a and 96b are actuated to rotate the motors 94a and 94b in the directions opposite to the aforesaid directions. When the driving gears 86a and 86b that are fixed to the respective drive shafts of the motors 94a and 94b-are rotated, the spur gears 84a and 84b are rotated in opposite directions with respect to the driving gears 86a and 86b. In this case, the spur gears 84a and 84b are rotated in the directions opposite to the directions indicated by arrows ε and ξ, respectively, in FIG. 5A. When the spur gears 84a and 84b are rotated, their mating racks 82a and 82b move. Thus, the shielding plates 74a and 74b move toward each other along the rails 80a and 80b.

If a vital sign of the patient 120 changes during the surgical operation, the signal output from the electrocardiograph or sphygmomanometer to the alarm display controller 92 may deviate from a predetermined range. In this case, the alarm display controller 92 delivers a sign indicative of an alarm and an output signal for displaying the content of the alarm to the CCUs 90L, 90R and 90W. The sign indicative of the alarm and the content of the alarm are displayed on the LCDs 62L and 62R and the miniature LCD 62W. The operator 30 can learn the content of the alarm from the display content.

As described above, the present embodiment provides the following effects.

The housing 44 of the stereoscopic observation apparatus 12 is provided with the second observation windows 54L and 54R and the open window portion 70 in the positions for the diagonally downward viewing indicated by arrow β in FIG. 1. If necessary, therefore, the lower region can be observed through the interior of the housing 44 of the observation apparatus 12. Since the open window portion 70 is provided with the magnifier 72, the field of observation can be enlarged. Thus, even though the operator must handle small suture needles outside the body cavity of the patient 120, he/she can quickly carry it out merely by minimally changing the posture without disengaging his/her face from the observation apparatus 12.

The open window portion 70 is closable by means of the shutter 74, and it can be closed when it is not used, so that light can be prevented from coming into the housing 44 from outside the stereoscopic observation apparatus 12. Thus, any other mode of observation, such as stereoscopic observation, can be carried out without hindrance. Since the alarm on the patient's conditions is displayed on the display screens for stereoscopic observation, the operator can grasp the patient's conditions while looking into the observation apparatus 12. Thus, the operator can be devoted to the surgical operation.

In the embodiment described above, the observation image can be enlarged by means of the magnifier 72 that is located in the open window portion 70. Alternatively, however, a wide-angle lens may be located in the open window portion 70 to enable wide-angle observation. Further, a magnifier and a wide-angle lens may be detachably arranged in the open window portion 70. In this case, either of the lenses to be used can be attached to the window portion 70 according to conditions for use. Alternatively, moreover, so-called through observation may be performed such that the exterior of the stereoscopic observation apparatus 12 is directly observed through the opening of the open window portion 70 without providing the window portion 70 with any optical member, such as the magnifier 72 or wide-angle lens.

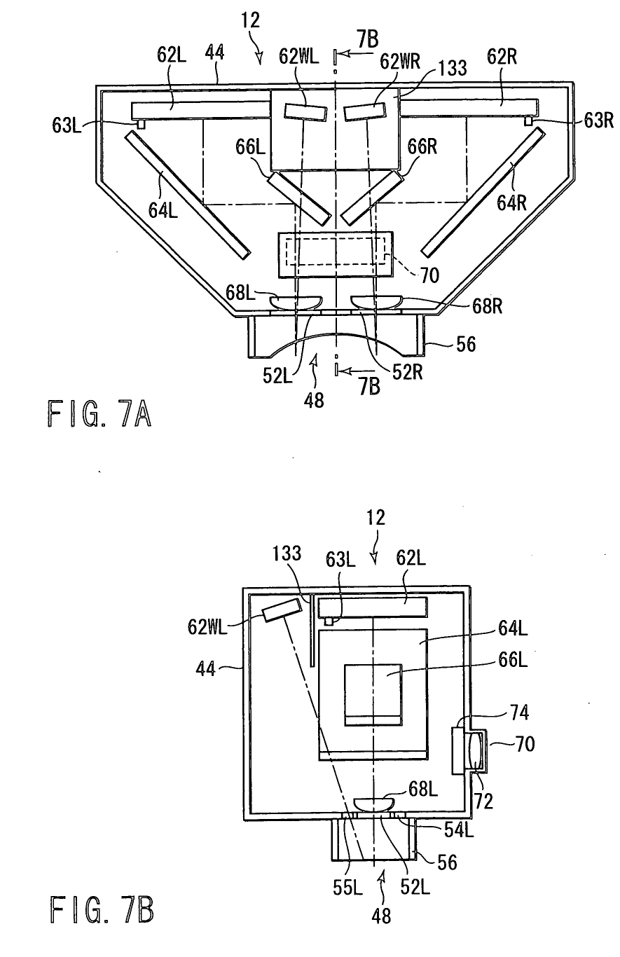

A second embodiment will now be described with reference to FIGS. 7A to 9B. This embodiment is a modification of the first embodiment. Therefore, like numerals are used to designate like members of the first and second embodiments, and a detailed description of those members is omitted.

As shown in FIGS. 7A and 7B, this embodiment dispenses with the first and second reflecting mirrors 64W and 66W and the miniature LCD 62W, on which the wide two-dimensional observation image that is picked up by the stereoendoscope 14 is displayed, according to the first embodiment. Instead, a pair of miniature LCDs 62WL and 62WR are arranged in the housing 44 of the stereoscopic observation apparatus 12. These miniature LCDs 62WL and 62WR are located in the inner upper part of the housing 44. A third left-eye observation window 55L and a third right-eye observation window 55R are arranged over the first observation windows 52L and 52R, respectively. Images displayed on the miniature LCDs 62WL and 62WR are directly landed on the third observation windows 55L and 55R, respectively. Thus, the images displayed on the miniature LCDs 62WL and 62WR can be observed through the third observation windows 55L and 55R.

Alternatively, the images displayed on the miniature LCDs 62WL and 62WR may be directly landed on the eyepiece lenses 68L and 68R. In this case, the images displayed on the miniature LCDs 62WL and 62WR can be enlargedly observed by means of the first observation windows 52L and 52R.

The miniature LCDs 62WL and 62WR for two-dimensional observation and the LCDs 62L and 62R for stereoscopic observation are separately located above and below. A screening plate 133 is interposed between the miniature LCDs 62WL and 62WR and the LCDs 62L and 62R. It serves to prevent scattered light or backlight from these LCDs from complicating the observation of the LCDs.

Alarm lamps 63L and 63R, typical display mechanisms of the alarm display controller 92, are arranged along those respective edges of the LCDs 62L and 62R for stereoscopic observation which are situated near the screening plate 133. Light transmitting mechanisms for transmitting the display on the display mechanisms to the observer's eyes in the eyepiece position for observation (see FIG. 1) may be provided separately without regard to the use of the alarm lamps 63L and 63R.

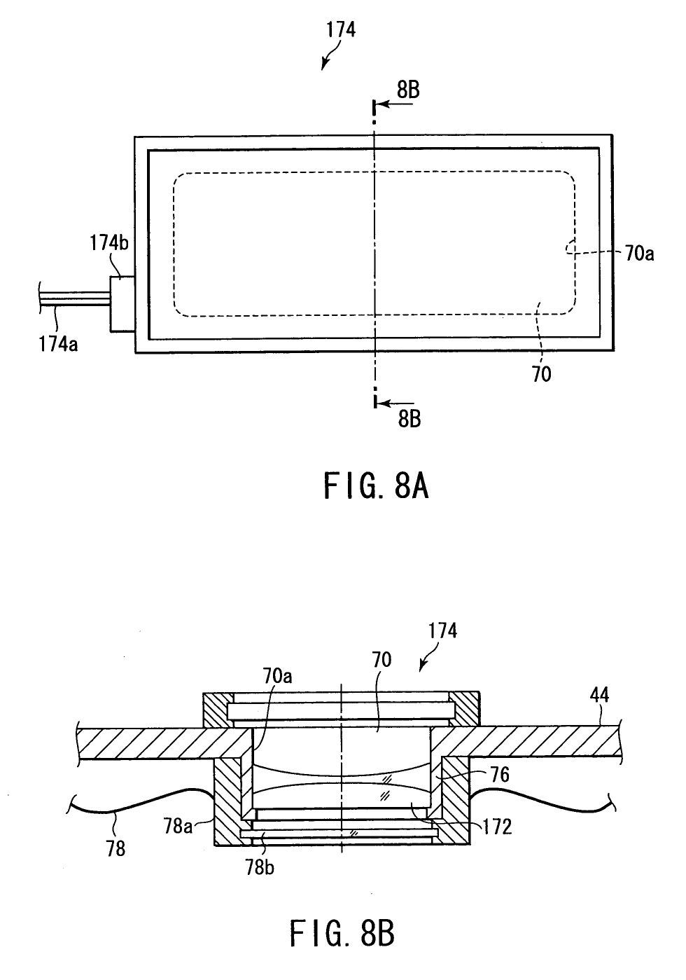

According to this embodiment, as shown in FIGS. 8A and 8B, a wide-angle lens (magnifier) 172 that has a square external shape is fixedly attached to the inside of the square hole 70a of the opening frame portion 76 with an adhesive agent (not shown) or the like. A liquid crystal shutter 174, capable of shielding the square hole 70a, is provided in place of the shutter 74 described in connection with the first embodiment.

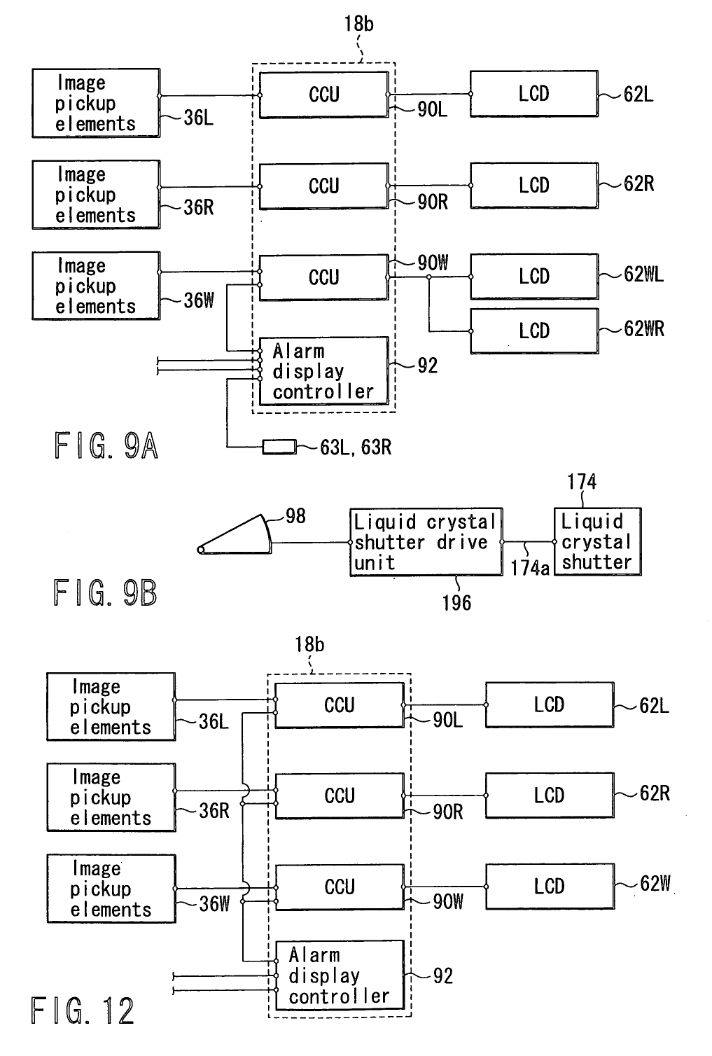

In the liquid crystal shutter 174, as shown in FIG. 8A, one end of a liquid crystal shutter driving cable 174a is connected to a connector 174b. The other end of the driving cable 174a is connected to a liquid crystal shutter drive unit 196 (mentioned later, see FIG. 9B).

FIG. 8B shows the positional relation between the wide-angle lens 172 and the liquid crystal shutter 174. When the shutter 174 is open, the lens 172 can be used for wide-angle observation. When the shutter 174 is closed, light outside the housing 44 of the stereoscopic observation apparatus 12 can be prevented from coming into the housing 44 through the lens 172.

FIGS. 9A and 9B are block diagrams showing connections between the devices according to the present embodiment. The miniature LCDs 62WL and 62WR are connected to the CCU 90W in the controller 18b. The CCU 90W for two-dimensional observation and the alarm lamps 63L and 63R are connected to the alarm display controller 92. If an alarm is needed, the alarm lamps 63L and 63R are lit in response to an output signal from the controller 92, and the content of the alarm is displayed on the LCDs 62WL and 62WR.

As shown in FIG. 9B, the footswitch 98 is connected to the liquid crystal shutter drive unit 196. The liquid crystal shutter 174 is driven by means of the drive unit 196. If the footswitch 98 is worked, the shutter 174 gets ready for transmission, thereby allowing enlarged observation through the wide-angle lens 172. If the footswitch 98 is worked again, the shutter 174 is closed.

The following is a description of the way a surgical operation is performed by using the observation system 10 constructed in this manner.

The operator looks in the housing 44 of the stereoscopic observation apparatus 12 at the first observation windows 52L and 52R, and stereoscopically observes the stereoscopic observation image from the stereoendoscope 14 by means of the LCDs 62L and 62R as he/she performs treatment. If the area around the region being treated requires wide-angle observation, the operator's eyes are moved upward from the visual line indicated by arrow α between the first observation windows 52L and 52R. Thereupon, a wide two-dimensional image that is obtained by means of the stereoendoscope 14 and displayed on the LCDs 62WL and 62WR can be observed.

Also in this case, the screening plate 133 divides the LCDs 62L and 62R for stereoscopic observation from the miniature LCDs 62WL and 62WR for wide-angle two-dimensional observation, so that the operator 30 can perform desired observation without being deceived by the stereoscopic observation images displayed on the LCDs 62L and 62R. Likewise, the operator can perform stereoscopic observation without being deceived by the two-dimensional image.

If the distal end of the stereoendoscope 14 is soiled, which hinders the observation during the surgical operation, the thin insertion section of the stereoendoscope 14 must be removed. In this case, the insertion section of the stereoendoscope 14 is inserted again into the patient's body cavity after it is removed from it. Thus, the operator works the footswitch 98 and moves his/her eyes to the second observation windows 54L and 54R. Then, he/she inserts the stereoendoscope 14 into the trocar 124 while observing the area around the body surface of the patient 120, including the opening of the trocar 124 for endoscope, through the wide-angle lens 172.

After this work is finished, the operator returns his/her eyes to the first observation windows 52L and 52R, and restarts the observation by means of the stereoendoscope 14. After the observation by means of the stereoendoscope 14 is restarted, the operator operates the footswitch 98 to close the liquid crystal shutter 174.

If the patient's vital sign changes during the surgical operation, the signal output from the electrocardiograph or sphygmomanometer to the alarm display controller 92 may deviate from a predetermined range. In this case, signals are delivered from the controller 92 to the alarm lamps 63L and 63R. When the lamps 63L and 63R receive the signals, they are lit. The moment the lamps 63L and 63R are lit, an output signal for displaying the content of the alarm is transmitted to the CCU 90W. Thereupon, the content of the alarm is displayed on the miniature LCDs 62WL and 62WR. If the operator 30, having so far been utilizing stereoscopic observation on the LCDs 62L and 62R, recognizes the alarm from the lit alarm lamps 63L and 63R, he/she moves his/her eyes to the observation windows 55L and 55R and confirms the content of the alarm.

As described above, the present embodiment provides the following effects.

In the present embodiment, the wide-angle lens 172 is located in the open window portion 70 of the stereoscopic observation apparatus 12, so that the operator can enlargedly confirm the conditions outside the body cavity of the patient 120 merely by minimally moving his/her eyes without disengaging his/her face from the observation apparatus 12. There is no other display than images on the display screens for stereoscopic observation, and necessary information such as an alarm is displayed on any of screens that are not observed during the work. Thus, the images that are required by the patient's treatment cannot be shielded.

Alternatively, so-called through observation may be performed such that the exterior of the stereoscopic observation apparatus 12 is directly observed through the opening of the open window portion 70 without providing the window portion 70 with any optical member, such as the wide-angle lens 172.

In this embodiment, the liquid crystal shutter 174 is used as the shutter. However, it may be replaced with a shutter of any other type, such as an electronically-driven type.

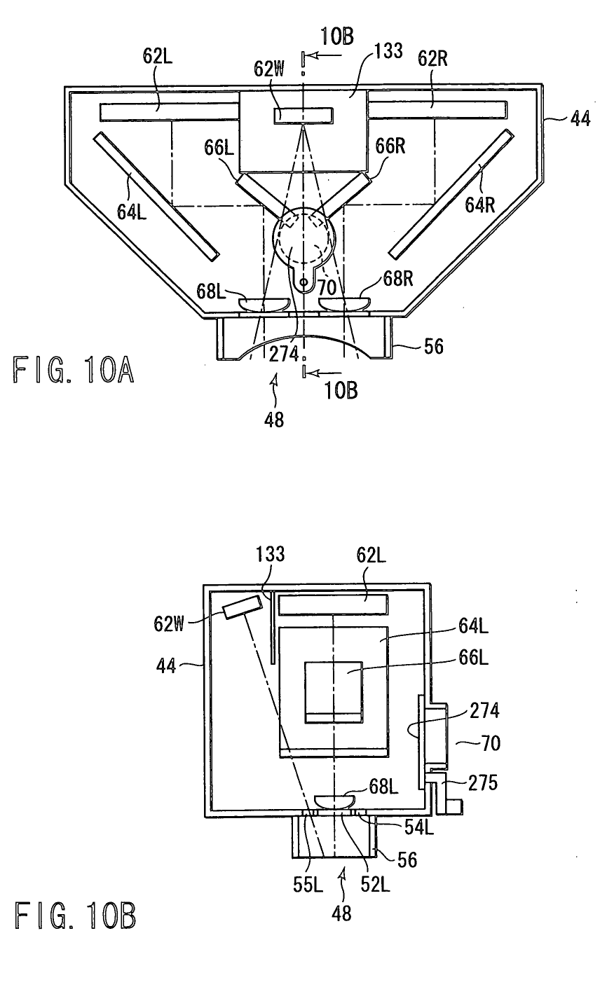

A third embodiment will now be described with reference to FIGS. 10A to 12. This embodiment is a modification of the first and second embodiments. Therefore, like numerals are used to designate like members of the first to third embodiments, and a detailed description of those members is omitted.

In this case, the square hole 70a of the open window portion 70 is provided with neither the magnifier 72 (see FIG. 5B) nor the wide-angle lens 172 (see FIG. 8B).

As shown in FIGS. 10A and 10B, the miniature LCD 62W is located in the inner upper part of the housing 44. An image displayed on the miniature LCD 62W is landed directly on the third left-eye observation window 55L that is located over the first left-eye observation window 52L. Thus, the image displayed on the miniature LCD 62W can be observed through the third observation window 55L.

As shown in FIGS. 10A and 10B, a rotary shutter 274 that can cover the square hole 70a is provided in place of the shutter 74 described in connection with the first embodiment.

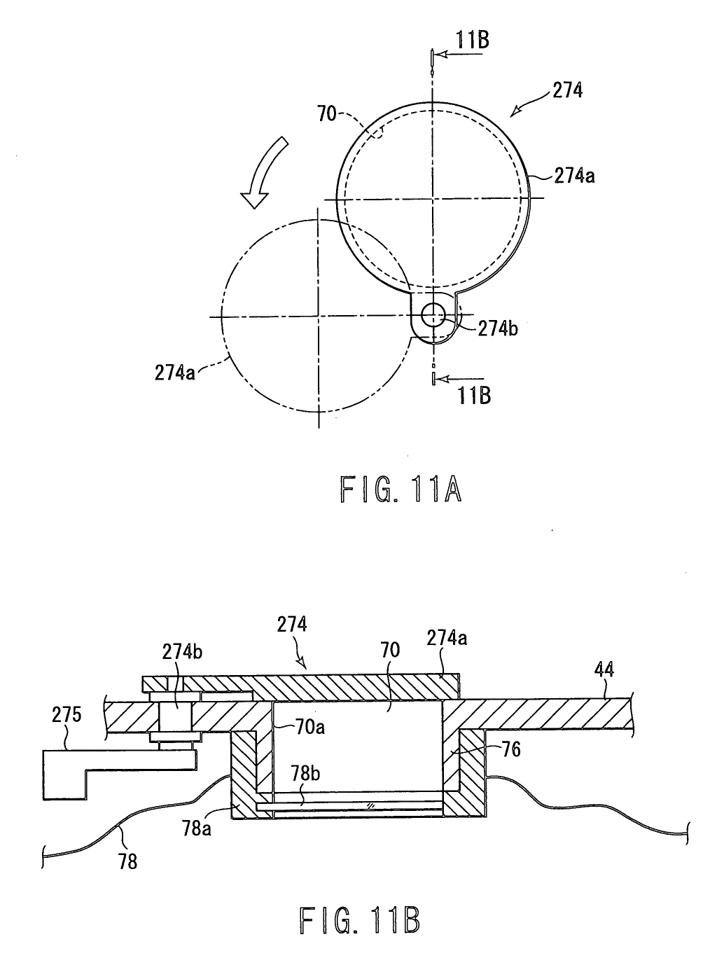

As shown in FIG. 11A, the rotary shutter 274 is provided with a shutter plate 274a, which is rockably mounted on a rotating shaft 274b that is supported on the housing 44. Fixed on the shaft 274b, as shown in FIG. 11B, is an operating lever 275 that is located outside the housing 44 of the stereoscopic observation apparatus 12.

If the operating lever 275 is worked to rotate the rotating shaft 274b, the shutter plate 274a is moved from a closed position for the square hole 70a, which is indicated by a solid line in FIG. 11A, to an open position indicated by two-dot chain line. Thus, the open window portion 70 is opened. As the operator's eyes are moved from the observation windows 52L and 52R toward the observation windows 54L and 54R on the lower side with the shutter plate 274a opened, so-called through observation can be performed such that the exterior of the stereoscopic observation apparatus 12 is directly observed through the opening of the open window portion 70.

FIG. 12 is a block diagram showing connections between the devices according to the present embodiment. In this arrangement, the alarm display controller 92 is connected to the three CCUs 90L, 90R and 90W described in connection with the first embodiment. Thus, the alarm display controller 92, unlike the one according to the first embodiment, is connected also to the CCU 90W. If necessary, therefore, the content of an alarm is displayed on the LCDs 62L and 62R and the miniature LCD 62W.

The following is a description of the way a surgical operation is performed by using the observation system 10 constructed in this manner.

In starting the operation, the operator 30 looks in the housing 44 of the stereoscopic observation apparatus 12, and stereoscopically observes the stereoscopic observation image from the stereoendoscope 14 by means of the LCDs 62L and 62R as he/she performs treatment. If the area around the observation target region 32 requires observation during the treatment, the operator moves his/her eyes from the first observation windows 52L and 52R to the observation windows 55L and 55R. Thereupon, a wide two-dimensional image that is obtained by means of the stereoendoscope 14 and displayed on the LCD 62W can be observed. Also in this case, the plate 133 divides the miniature LCD 62W from the LCDs 62L and 62R, so that the operator 30 can perform desired observation without being deceived by the stereoscopic observation images displayed on the LCDs 62L and 62R. Likewise, the operator can perform stereoscopic observation without being deceived by the two-dimensional image.

If the area around the body surface of the patient 120 must be observed during the surgical operation, the operator 30 moves his/her eyes to the second observation windows 54L and 54R and works the operating lever 275 to open the rotary shutter 274. By doing this, a desired position can be observed straight. The observation by means of the stereoendoscope 14 can be restarted by returning the visual line to the first observation windows 52L and 52R. If no light is expected to be incident from outside the stereoscopic observation apparatus 12, the operating lever 275 is worked to close the rotary shutter 274.

If the patient's vital sign changes during the surgical operation, the signal output from the electrocardiograph or sphygmomanometer to the alarm display controller 92 may deviate from a predetermined range. In this case, output signals are delivered from the controller 92 to the three CCUs 90L, 90R and 90W, whereupon the alarm content is displayed on the LCDs 62L, 62R and 62W.

As described above, the present embodiment provides the following effects.

In the stereoscopic observation apparatus 12 according to the present embodiment, the open window portion 70 for observing the external state is provided with the shutter 274 that can be opened and closed manually and is not fitted with any optical component, such as a lens. Thus, the observation apparatus 12 can be made small-sized, light in weight, and low-priced.

Since the alarm content is displayed on both the display devices for stereoscopic observation and wide-range observation, the operator can grasp the alarm content in an instant without regard to the screen he/she is watching.

All of the stereoscopic observation apparatuses according to the embodiments described above are of the so-called virtual-image stereoscopic observation type. Alternatively, however, a first image for the left eye and a second image for the right eye, which are picked up with a parallax by image pickup units, may be displayed alternately and sequentially as parallactic images on the same screen on a TV monitor for use as a display unit. The observer wears glasses having a shutter function for sequential left-right switching that is synchronized with the sequential image switching, and observes with his/her left and right eyes the left- and right-hand parallactic images that are displayed alternately on the TV monitor. Thus, the stereoscopic observation apparatus may be of the stationary TV monitor type, capable of the stereoscopic observation described herein.

Further, organic ELs or the like may be used in place of the LCDs 62L and 62R and the miniature LCDs 62W, 62WL and 62WR described in connection with the foregoing embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An observation apparatus comprising:
a housing;
a pair of display devices which is located in the housing so as to be connected to a stereoscopic observation mechanism, through which an observation target region is observed stereoscopically, and correspondingly displays a pair of different images for stereoscopic observation obtained from the stereoscopic observation mechanism;
an eyepiece portion attached to the housing and having a pair of observation windows through which images displayed individually on the display devices is observed by left and right eyes, individually;
a window portion attached to the housing and formed having an opening through which an external area around the housing is observed by means of the eyepiece portion; and
a shutter which is attached to the housing and opens and closes the window portion.

2. An observation apparatus according to claim 1, wherein the eyepiece portion further includes another observation window through which the area outside the housing is obtained through the window portion and located under the pair of observation windows.

3. An observation apparatus according to claim 1, wherein the shutter includes a shielding plate movable with respect to the window portion and a moving mechanism which moves the shielding plate with respect to the window portion.

4. An observation apparatus according to claim 3, wherein the moving mechanism includes a first gear mechanism attached to the shielding plate, a motor having a second gear mechanism in engagement with the first gear mechanism, a motor control unit which is connected to the motor and controls the rotating direction of the motor, and a footswitch which is connected to the motor control unit and applies an actuating signal to the motor control unit.

5. An observation apparatus according to claim 3, wherein the moving mechanism includes a rotating shaft attached to the housing and supporting the shielding plate.

6. An observation apparatus according to claim 5, wherein the moving mechanism further includes an operating portion which rotates the rotating shaft.

7. An observation apparatus according to claim 1, wherein the shutter includes an electronically-driven shutter and a footswitch which is connected to the electronically-driven shutter and opens and closes the electronically-driven shutter.

8. An observation apparatus according to claim 7, wherein the electronically-driven shutter is a liquid crystal shutter.

9. An observation apparatus according to claim 3, wherein the window portion includes an enlargement optical system which enlarges the scale of the field of view from the window portion.

10. An observation apparatus according to claim 3, wherein the window portion includes a wide-angle optical system which enlarges the field of view from the window portion.

11. An observation apparatus according to claim 3, wherein the housing is further provided with another display device which is located in a position different from those of the pair of display devices and is observed from the eyepiece portion.

12. An observation apparatus according to claim 11, wherein the eyepiece portion includes another observation window through which the other display device is be observed.

13. An observation apparatus according to claim 11, which further includes a screening plate which is located between the other display device and the pair of display devices and prevents scattered lights from the display devices from entering an optical path between the eyepiece portion and the display devices.

14. An observation apparatus according to claim 1, wherein the window portion includes an enlargement optical system which enlarges the scale of the field of view from the window portion.

15. An observation apparatus according to claim 1, wherein the window portion includes a wide-angle optical system which enlarges the field of view from the window portion.

16. An observation apparatus according to claim 1, wherein the housing is further provided with another display device which is located in a position different from those of the pair of display devices and is observed from the eyepiece portion.

17. An observation apparatus according to claim 16, wherein the eyepiece portion includes another observation window through which the other display device is observed.

18. An observation system comprising:
a stereoscopic observation mechanism through which an observation target region is observed stereoscopically;
a housing;
a pair of display devices which is located in the housing so as to be connected to the stereoscopic observation mechanism and is correspondingly display a pair of different images for stereoscopic observation observed by means of the stereoscopic observation mechanism;
an eyepiece portion attached to the housing and having at least a pair of observation windows through which images displayed individually on the display devices is observed by left and right eyes, individually;
a window portion attached to the housing and formed having an opening through which an area around the housing is observed by means of the eyepiece portion; and
a shutter which is attached to the housing and opens and closes the window portion.

19. An observation system according to claim 18, wherein the stereoscopic observation mechanism includes at least a pair of observation optical systems capable of displaying picked-up images on the pair of display devices.

20. An observation system according to claim 19, wherein the stereoscopic observation mechanism includes another observation optical system through which a peripheral area including regions observed by means of the pair of observation optical systems is observed.

21. An observation system according to claim 18, wherein the housing is provided with another display device which is located in a position different from those of the pair of display devices, displays an image picked up by the other observation optical system, and is observed from the eyepiece portion.

22. An observation system according to claim 21, wherein the eyepiece portion includes another observation window through which the other display device is observed.

23. An observation system according to claim 18, which further includes an alarm display controller located between the stereoscopic observation mechanism and the pair of display devices and connected to an apparatus which measures a patient's vital sign, and wherein the housing is provided with an alarm display element on which an alarm delivered from the alarm display controller is displayed.

24. An observation system according to claim 23, wherein the alarm display controller is attached to the pair of display devices.
